(19) United States
(12) Patent Application Publication
(10) Pub. No.: US 2018/0045310 A1
(43) Pub. Date: Feb. 15, 2018

(54) Housing Cap for a Joint, and Assembly Composed of a Joint and a Shaft

(71) Applicant: Neumayer Tekfor Engineering GmbH, Hausach (DE)

(72) Inventor: Thomas ETZOLD, Offenburg (DE)

(21) Appl. No.: 15/793,048

(22) Filed: Oct. 25, 2017

Related U.S. Application Data
(63) Continuation of application No. PCT/DE2016/000223, filed on May 25, 2016.

(30) Foreign Application Priority Data
Jun. 5, 2015 (DE) 10 2015 007 451.2

(51) Int. Cl. F16J 3/04; F16D 3/84; F16D 3/41; F16J 15/52

(52) U.S. Cl. CPC F16J 3/043; F16J 15/52; F16D 3/845; F16J 3/042; F16D 3/41; F16D 2003/22326

(57) ABSTRACT

A housing cap for a joint and a joint arrangement with a housing cap are provided. The housing cap includes a bellows section and a joint section. The bellows section includes at least one recess in the form of a hole configured to permit dirt and fluids to pass out of the housing cap. The bellows portion may also be provided with surface features such as funnel-shapes configured to enhance transport of contaminates and fluids to the at least one recess.

### CROSS REFERENCE TO RELATED APPLICATIONS

This application is a continuation of PCT International Application No. PCT/DE2016/000223, filed May 25, 2016, which claims priority under 35 U.S.C. §119 from German Patent Application No. 10 2015 007 451.2, filed Jun. 5, 2015, the entire disclosures of which are herein expressly incorporated by reference.

### BACKGROUND AND SUMMARY OF THE INVENTION

The invention relates to a housing cap for a joint having a folding bellows portion and having a joint portion. Furthermore, the invention relates to an arrangement comprising a joint and a shaft, having a housing cap and a folding bellows, wherein the housing cap has a folding bellows portion and a joint portion and wherein the housing cap comprises an outer hub of the joint and the folding bellows, wherein the folding bellows is arranged between the joint and the shaft which is connected to the joint.

Housing caps are used in particular in the automotive industry and serve to protect joints which are placed in particular in the drive train of a vehicle. The drive train comprises the components which transmit the torque from the engine to the road. The joints themselves are often constructed as slip joints in the form of counter track joints and comprise a plurality of components which engage one in the other. A penetration of dirt particles in these joints would lead to damage, potentially even destruction of the joints, and accordingly has to be prevented, but at least reduced. The housing caps achieve this effect.

From the prior art, various housing caps are known, for example, from DE 100 20 641 A1. In order not to limit the movability of the shaft, it is necessary for the housing caps to be open at the end facing the shaft. As a result, contamination and water from the road surface can reach the housing cap. Depending on the nature of the driving surface, this can occur in considerable quantities. The contamination is not discharged from the housing cap again by itself and can also be removed therefrom only with difficulty. Often for a thorough cleaning, complete disassembly is required. If the contamination is not removed, however, this may lead to corrosion, in particular to crevice corrosion of the housing cap. In addition, there is a risk of the joints becoming damaged, in particular the folding bellows which is produced from a rubber-like material.

The object of the invention is accordingly to provide a housing cap with reduced affinity for depositing contamination.

The object introduced and set out above is achieved according to the invention in that the housing cap has in the folding bellows portion at least one recess. As a result of the recess according to the invention, it is possible for the contamination and fluids being introduced into the housing cap to be discharged through the recess, that is to say, directed through the housing cap. A deposit of contamination is thereby reduced so that the susceptibility to corrosion of the housing cap is significantly reduced. However, if contamination nonetheless accumulates at some locations inside the housing cap a fluid can be directed through the recess, whereby a cleaning effect is achieved. The housing cap according to the invention has a significantly higher service-life than housing caps known from the prior art.

The effect achieved occurs both in the static and in the rotating operating state of the housing cap. In the rotating operating state, the self-cleaning effect is naturally greater than in the static state since the accumulated liquids and/or contamination as a result of the centrifugal forces acting on them are thrown outwards through the recesses.

According to the invention, the recess may have any diameter. In order to achieve the above-mentioned effect, however, it is self-evident that the recess has to at least be larger than the size of the dirt particles which are discharged through them. Another advantage in the embodiment of a housing cap with a recess is in the resulting weight reduction of the housing cap. The larger the recess, the lighter the housing cap. Naturally, it must be ensured that the housing cap does not become unstable as a result of the recess. In the question of the size of the recess, a balance has to be achieved between the necessary size in order to ensure discharge of the dirt particles, an advantageous weight reduction and the stability of the housing cap.

A preferred embodiment of the housing cap according to the invention is characterized in that the housing cap is formed in a cylindrical manner in the folding bellows portion.

In a particularly preferred manner, the cylindrical housing cap has such a cross-section that it is rotationally symmetrical. Above all in the rotating operating state, a rotationally symmetrical housing cap is found to be particularly advantageous. Imbalances are thereby prevented. A cylindrical formation with a circular cross-section is particularly advantageous. The cylindrical formation—in particular with a circular cross-section is additionally found to be particularly advantageous since the cylinder itself has no corners and edges in which contamination can accumulate, in particular no edges and corners in which the contamination can be pressed by means of the centrifugal forces.

Another embodiment of the housing cap according to the invention is characterized in that the recess has at least one circular bordering portion. In particular, there may be provision for the border of the recess to be completely circular.

In another embodiment of the housing cap according to the invention, there is provision for the recess to have at least one linear bordering portion.

Of course, the recess may also have both circular and linear bordering portions. There may, for example, be provision for the recess to have a substantially rectangular border but in which the corners are rounded.

In particular, it is recommended that the recess have no sharp edges. Since the housing cap is arranged around the folding bellows, the folding bellows should be prevented from coming into contact with sharp edges which could lead to damage to the folding bellows.

The recesses are punched out of the housing cap. Simple geometric bordering shapes are accordingly particularly preferred. The production of the recesses is, however, not limited to a punching operation, other known methods which are suitable for producing recesses can also be used.

A particularly preferred embodiment of the housing cap according to the invention is characterized in that the housing cap has a funnel-like—in particular conical or pyramid-like—embossing in the region of the recess, wherein the recess is arranged at an end face on a tapered portion of the funnel-like embossing.

As a result of this preferred embodiment, the effect of the expulsion of the contamination and liquids is further reinforced since the embossing according to the invention achieves a funnel-like effect. As a result of the funnel-like embossings, the contamination and/or fluids are directed in a selective manner to the recesses so that an influx from the axial and radial direction to the recesses is enabled.

According to the invention, there are a large number of embodiments of the funnel-like embossing. Both the conical and the pyramid-like embossing may have a different embodiment. If the funnel-like embossing is constructed in a conical manner, the recess is located at the tip of the cone. The cone itself may be produced as a linear or oblique cone of any height. The base face of the cone may be circular with any radius. The base face may also be constructed in an elliptical manner with any length of the half axes.

If the funnel-like embossing is constructed in a pyramid-like manner, an embodiment of the housing cap is characterized in that there are any number of side faces of the pyramid-like embossing. The pyramid may be a regular or an irregular pyramid of any height, wherein the recess is formed at the tip of the pyramid. The pyramid may also be constructed as a linear pyramid. There may also be provision for the funnel-like embossing to be produced as an oblique pyramid. The base face is based on the number and embodiments of the side faces of the pyramid, but may have any extent.

In principle, the housing cap should have a construction which prevents or at least minimizes any risk of wear and damage to the folding bellows. This may in particular be achieved in that the spacing between the housing cap and folding bellows is maximized. A preferred embodiment of the housing cap according to the invention is characterized in that the housing cap in the folding bellows portion has a bulbous shape and the recess is provided at the height of the largest periphery of the folding bellows portion. The bulbous shape faces radially outwards in this instance. In particular, such an embodiment has the advantage that as a result of the additional bulbous shape of the housing cap an influx to the recesses is facilitated. The bulbous shape may according to the invention be provided without the above-mentioned funnel-like embossings, but it is also advantageous to provide the bulbous shape in addition to the funnel-like embossings. It is then particularly advantageous for the maximum configuration of a funnel-like embossing to be located on the same peripheral line as the maximum configuration of the bulbous shape.

There may also be provision for the bulbous shape to face radially inwards. With such an embodiment, it should be ensured that the spacing between the housing cap and the folding bellows is not too small to prevent damage to the folding bellows. The recesses are also with an inwardly directed bulbous form provided at the height of the largest periphery of the folding bellows portion.

If it is set out that the housing cap has at least one recess, the housing cap may also have a plurality of recesses. A preferred embodiment of the housing cap according to the invention is characterized in that a plurality of recesses are provided, wherein the recesses and/or the funnel-like embossings are each constructed in a substantially identical manner. An embodiment is accordingly characterized in that all the recesses have substantially the same border. Another embodiment is characterized in that the funnel-like embossings in the region of the recesses are constructed in a substantially identical manner.

Another embodiment of the housing cap according to the invention is characterized in that a plurality of recesses are provided, wherein at least two of the recesses have a mutually different border and/or at least two of the funnel-like embossings are constructed differently from each other. Such a housing cap may accordingly have recesses with different borders and different funnel-like embossings in the region of the recesses.

If the housing cap has at least two recesses, then a specific embodiment of the housing cap according to the invention is characterized in that the recesses have regular spacings with respect to each other. If two recesses are provided, therefore, it is recommended that the recesses be arranged facing each other.

As a result of a regular arrangement of the recesses, an imbalance during rotation of the housing cap is prevented, that is to say, the main axis of inertia is prevented from coinciding with the rotation axis. An imbalance is prevented since fluids which occur or generally media can be uniformly discharged from the housing cap. An imbalance would, on the one hand, lead to increased wear and, on the other hand, possibly cause vibrations.

If a plurality of recesses are provided in the housing cap, then the recesses may be provided on a peripheral line at a height of a longitudinal axis of the housing cap. As a result of such an embodiment, in particular a uniform discharge of contamination and fluids is promoted. The housing cap according to the invention is, however, not limited to such an embodiment. It may also be found to be advantageous to arrange the recesses not on a peripheral line at a height of a longitudinal axis of the housing cap, but instead in an offset manner. Even with an offset arrangement, the recesses should be provided with regular spacings from each other.

As mentioned in the introduction, housing caps of the type mentioned are used in particular in the automotive industry and serve to protect joints which are placed in particular in the drive train of a vehicle. The invention accordingly also relates to an arrangement comprising a joint and a shaft, having a housing cap and a folding bellows, wherein the housing cap has a folding bellows portion and a joint portion and wherein the housing cap comprises an outer hub of the joint and the folding bellows, wherein the folding bellows is arranged between the joint and the shaft which is connected to the joint. The object of the invention is achieved with the arrangement mentioned in that the housing cap is produced in accordance with one of the embodiments carried out.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a first embodiment of the housing cap according to the invention,

FIG. 2 shows a second embodiment of the housing cap according to the invention,

FIG. 3 shows a third embodiment of the housing cap according to the invention,

FIG. 4 shows a fourth embodiment of the housing cap according to the invention,

FIG. 5 shows an arrangement comprising a joint and a shaft with a housing cap according to the invention.

### DETAILED DESCRIPTION OF THE DRAWINGS

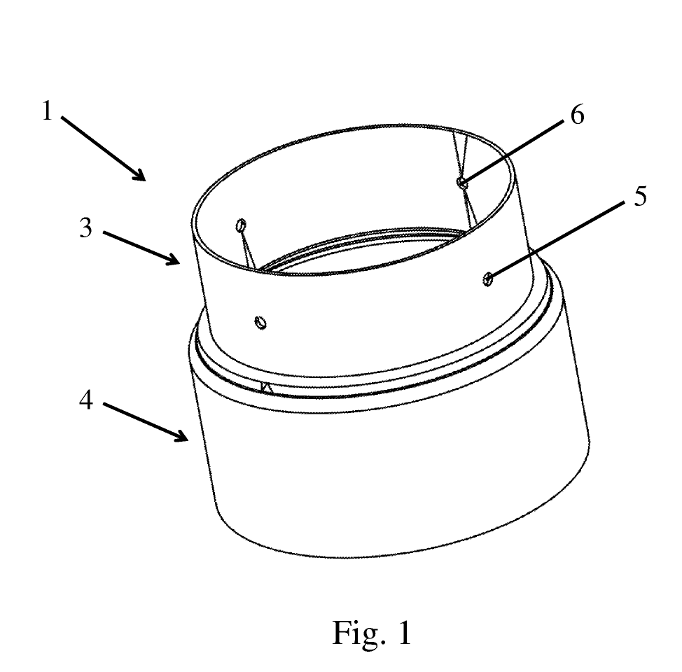

FIG. 1 shows a first embodiment of the housing cap 1 according to the invention. The housing cap 1 has a folding bellows portion 3 and a joint portion 4. Both the folding bellows portion 3 and the joint portion 4 are formed in a cylindrical manner, wherein the outer diameter of the joint portion 4 is greater than the outer diameter of the folding bellows portion 3. In the folding bellows portion 3 there are four recesses 5. The recesses 5 are all constructed in an identical manner, that is to say, have a circular border 6. The recesses have such a size that contamination, for example, in the form of dirt particles, passes through unimpeded. The four recesses 5 are each arranged spaced apart from each other by 90°, thus have a regular spacing with respect to each other. The recesses 5 are arranged on a peripheral line at the center of the longitudinal extent of the folding bellows portion 3.

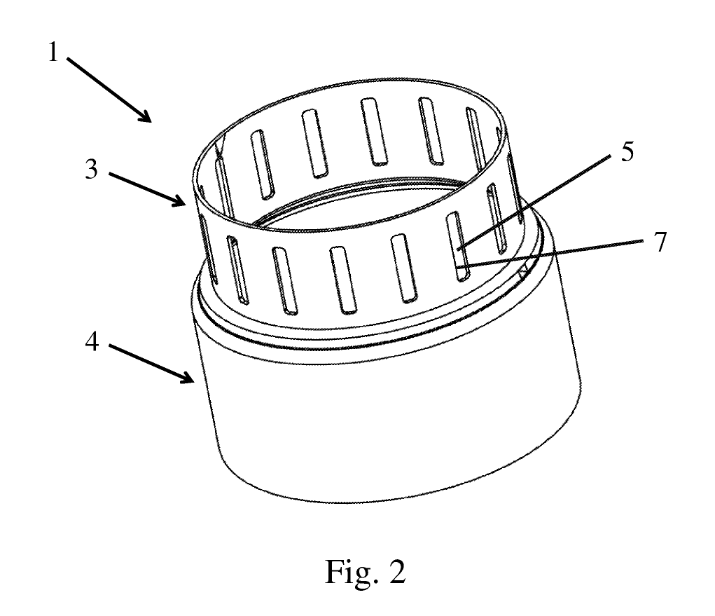

The embodiment illustrated in FIG. 2 of the housing cap 1 according to the invention differs from the embodiment illustrated in FIG. 1 as a result of the number and configuration of the recesses 5 in the folding bellows portion 3. The housing cap 1 has sixteen recesses 5 which are arranged with regular spacing with respect to each other. The recesses 5 themselves are constructed in an identical manner and have a substantially rectangular shape, wherein the corners of the recesses 5 are rounded. Furthermore, the recesses 5 are arranged on a peripheral line at the center of the longitudinal extent of the folding bellows portion 3. If a housing cap has a large number of recesses, the advantage is afforded that the weight of the housing cap is reduced by a non-negligible factor.

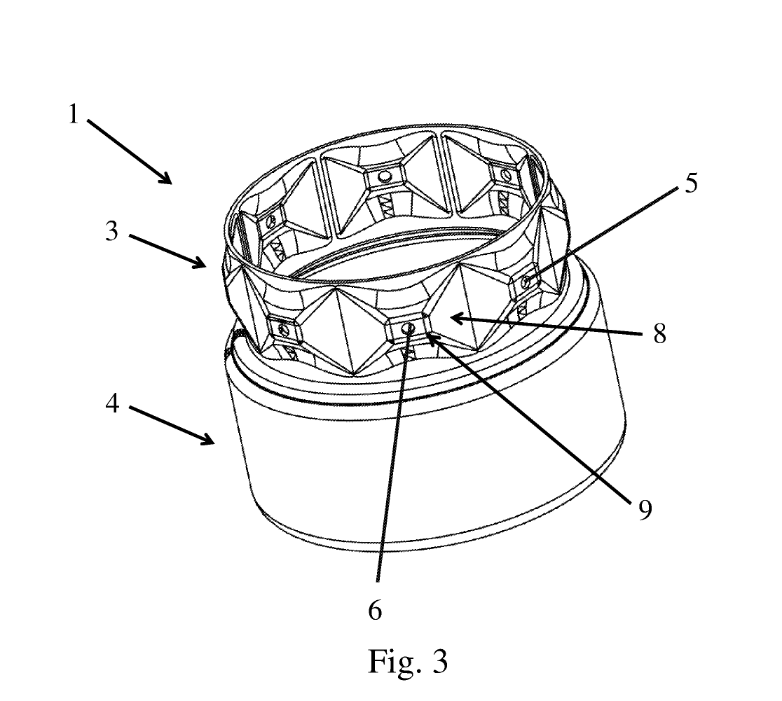

In order to direct the accumulated contamination or fluid in a selective manner to the recesses 5, the housing cap 1 illustrated in FIG. 3 has in the region of the folding bellows portion 3 funnel-like embossings 8. The funnel shape is produced by means of a pyramid-like construction, wherein the pyramid has a substantially rectangular base face and substantially four side faces. The base faces which follow each other in the longitudinal direction of the housing cap 1 have in this instance an additional embossing and are composed of four part-faces. The steep edges of the pyramid are each flattened. At the end face 9 of the funnel-like embossing 8, that is to say, at the tapered portion of the funnel-like embossing 8 there are the recesses 5 which have a circular periphery 6.

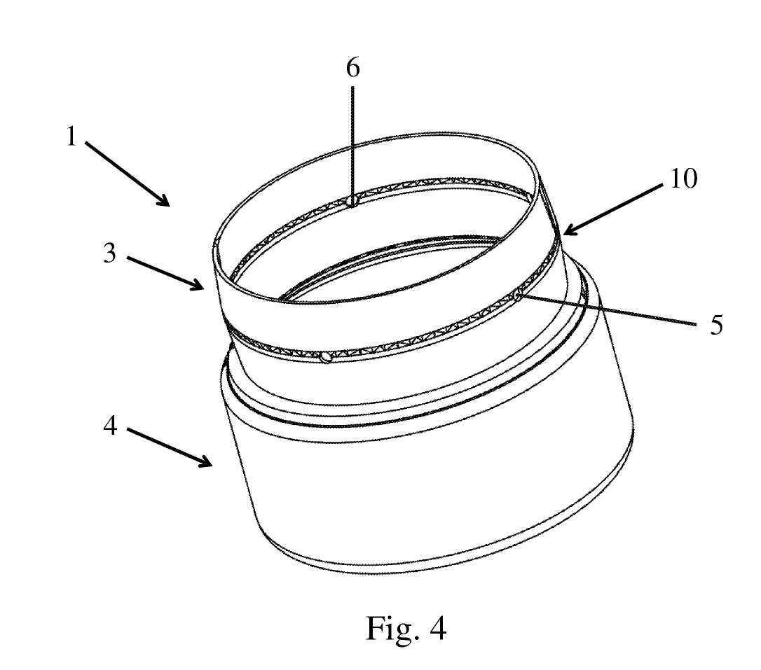

FIG. 4 shows an embodiment of the housing cap 1 according to the invention in which the folding bellows portion 3 has a bulbous shape 10. The largest periphery of the folding bellows portion 3 is at the center of the longitudinal extent of the folding bellows portion. At the height of the largest periphery there are five recesses 5 which, in the same manner as the recesses 5 illustrated in FIG. 1, have a circular border 6. The recesses 5 are arranged with regular spacings with respect to each other. As a result of the bulbous shape of the folding bellows portion 3, an influx of contamination to the recesses 5 is promoted so that self-cleaning of the joint or the housing cap is further promoted.

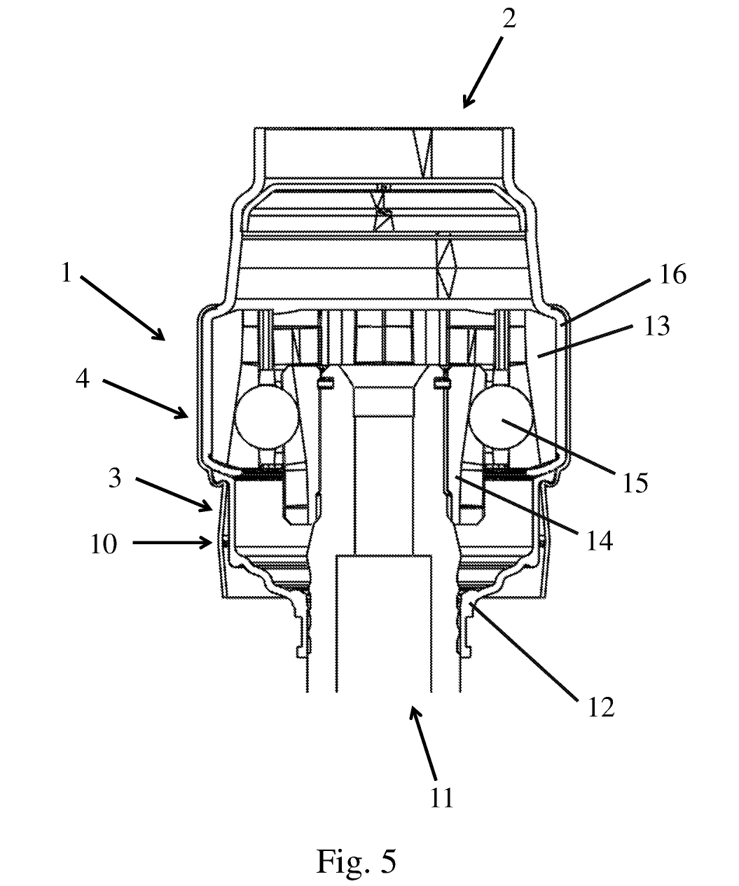

FIG. 5 shows an arrangement comprising a joint 2 and a shaft 11 with a housing cap 1 and a folding bellows 12. The joint 2 has an outer hub 13 and an inner hub 14. A ball 15 is supported between the outer hub 13 and the inner hub 14. The joint 2 is surrounded by a housing 16 which surrounds the outer hub 13. The folding bellows 12 adjoins the housing 16. The housing cap 1 has a folding bellows portion 3 and a joint portion 4, wherein the joint portion 4 comprises the outer hub 13 and a portion of the housing 16 which surrounds the joint 2, that is to say, the portion of the housing 16 in the region of the outer hub 13. The folding bellows portion 3 of the housing cap 1 surrounds a portion of the folding bellows 12. The housing cap 1 is constructed to be open at the end thereof facing the shaft 11. Contamination and fluids thereby reach the housing cap 1. The housing cap illustrated in FIG. 5 has a bulbous shape 10, whereby a discharge of accumulating contamination and fluids through recesses which cannot be seen in FIG. 5 is promoted.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A housing cap for a joint, comprising:
a folding bellows portion; and
a joint portion,
wherein
the folding bellows portion includes a recess, and
the recess is configured in the folding bellows portion in a manner that permits discharge of contamination and fluids introduced into the housing cap.

2. The housing cap as claimed in claim 1, wherein
the folding bellows portion is cylindrical.

3. The housing cap as claimed in claim 1, wherein
the recess has a circular bordering portion.

4. The housing cap as claimed in claim 1, wherein
the recess has a linear bordering portion.

5. The housing cap as claimed in claim 1, wherein
the recess is arranged in a funnel-shaped embossing in the folding bellows portion, and
the recess is arranged at an end face on a tapered portion of the funnel-shaped embossing.

6. The housing cap as claimed in claim 1, wherein
the folding bellows portion includes a bulbous shape, and
the recess is provided at a height of a largest periphery of.

7. The housing cap as claimed in claim 1, wherein
the recess is one of a plurality of recesses, and
the plurality of recesses have the same shape.

8. The housing cap as claimed in claim 7, wherein
the plurality recesses are arranged at circumferentially around the folding bellows portion at regular spacings.

9. The housing cap as claimed in claim 1, wherein
the recess is one of a plurality of recesses,
the plurality of recesses are arranged in a funnel-shaped embossing in the folding bellows portion, and
the funnel-like embossings have the same shape.

10. The housing cap as claimed in claim 1, wherein
the recess is one of a plurality of recesses, and
at least two of the recesses have a mutually different border.

11. The housing cap as claimed in claim 1, wherein
the plurality of recesses are arranged in a funnel-shaped embossing in the folding bellows portion.

12. The housing cap as claimed in claim 1, wherein
the recess is one of a plurality of recesses,
the plurality of recesses are arranged in a funnel-shaped embossing in the folding bellows portion, and
at least two of the funnel-like embossings have different shapes.

13. An joint arrangement, comprising
a joint;
a shaft configured to be inserted into the joint and
a housing cap configured to surround at least a portion of the joint,
wherein
the housing cap includes a folding bellows portion and a joint portion,
the folding bellows portion includes a recess, and
the recess is configured in the folding bellows portion in a manner that permits discharge of contamination and fluids introduced into the housing cap.

14. An joint arrangement, comprising
a joint configured to receive a shaft; and
a housing cap configured to surround at least a portion of the joint,
wherein
the housing cap includes a folding bellows portion and a joint portion,
the folding bellows portion includes a recess, and
the recess is configured in the folding bellows portion in a manner that permits discharge of contamination and fluids introduced into the housing cap.
